(19) United States
(12) Patent Application Publication
(10) Pub. No.: US 2025/0333577 A1
(43) Pub. Date: Oct. 30, 2025

(54) ARTICLE AND METHOD OF MAKING

(71) Applicant: SAINT-GOBAIN PERFORMANCE PLASTICS CORPORATION, Solon, OH (US)

(72) Inventors: Nicholas WATKINS, Natick, MA (US); Adam J. STEVENSON, Rutland, MA (US)

(21) Appl. No.: 19/194,955

(22) Filed: Apr. 30, 2025

Related U.S. Application Data
(60) Provisional application No. 63/640,536, filed on Apr. 30, 2024.

(51) Int. Cl. C08K 3/22; B32B 1/08; B32B 25/20

(52) U.S. Cl. CPC C08K 3/22; B32B 1/08; B32B 25/20; B32B 2250/02; C08K 2003/2213; C08K 2003/2244; C08K 2003/2262; C08K 2201/012

(57) ABSTRACT

The subject application relates to an article and method of making. An article includes a polymer composition, the polymer composition including a silicone elastomer and a hydrogen peroxide degradation catalyst.

### CROSS-REFERENCE TO RELATED APPLICATION(S)

This Application claims priority under 35 U.S.C. § 119(e) to U.S. Provisional Patent Application No. 63/640,536 entitled “ARTICLE AND METHOD OF MAKING,” filed Apr. 30, 2024, by Nicholas WATKINS, which is assigned to the current assignee hereof and is incorporated herein by reference in its entirety.

### FIELD OF THE DISCLOSURE

This disclosure, in general, relates to an article and method of forming the article.

### BACKGROUND

Silicone-based materials are widely used for their properties desired in medical, pharmaceutical, food, and biological industries. For instance, silicone-based materials typically are non-toxic, flexible, thermally stable, have low chemical reactivity, and can be produced in a variety of sizes. However, challenges remain with currently available silicone products. When the silicone product is exposed to vapor hydrogen peroxide sterilization, there are concerns with degradation of the article with hydrogen peroxide permeating into the silicone product.

The development of silicone products that can withstand vapor hydrogen peroxide sterilization without accumulation of hydrogen peroxide in the article would be advantageous. More particularly, an improved silicone-based tube is desired.

### SUMMARY

In an embodiment, an article includes a polymer composition, the polymer composition including a silicone elastomer and a hydrogen peroxide degradation catalyst.

In an embodiment, a method of providing an article includes: providing a polymer composition including a silicone elastomer and a hydrogen peroxide degradation catalyst; and shaping the polymer composition into an article.

In an embodiment, an article includes an inner layer including an elastomeric polymer; and an outer layer including a polymer composition, the polymer composition includes a silicone elastomer and a hydrogen peroxide degradation catalyst.

In another embodiment, an article includes a polymer composition, the polymer composition including a silicone elastomer and a hydrogen peroxide degradation catalyst, wherein the hydrogen peroxide degradation catalyst includes a metal oxide present at an amount of 0.1 wt % to 30 wt %, such as 1 wt % to 30 wt %, such as 1 wt % to 20 wt %, such as 1 wt % to 10 wt %, or even 1 wt % to 5 wt %, based on the total weight of the polymer composition.

### BRIEF DESCRIPTION OF THE DRAWINGS

The present disclosure may be better understood, and its numerous features and advantages made apparent to those skilled in the art by referencing the accompanying drawings.

FIGS. 1 and 2 include illustrations of exemplary tubes.

FIG. 3 includes a graphical depiction of an absorbance graph of standard H₂O₂ dilutions with peak at 585 nm as discussed in the Examples.

FIG. 4 includes a graphical depiction of a standard curve for H₂O₂ concentrations from 0-1000 μM as discussed in the Examples.

The use of the same reference symbols in different drawings indicates similar or identical items.

### DETAILED DESCRIPTION

The following description in combination with the figures is provided to assist in understanding the teachings disclosed herein. The following discussion focuses on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having”, or any other variation thereof, are open-ended terms and should be interpreted to mean “including, but not limited to . . . ”. These terms encompass the more restrictive terms “consisting essentially of” and “consisting of” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 25° C. For instance, values for viscosity are at 25° C., unless indicated otherwise.

In a particular embodiment, an article includes a polymer composition. The polymer composition includes a silicone elastomer and a hydrogen peroxide degradation catalyst. The polymer composition advantageously increases the life of an article and more particularly, when exposed to hydrogen peroxide during a vapor sterilization process. In an embodiment, the article has a decreased accumulation of hydrogen peroxide when exposed to vapor hydrogen peroxide sterilization. In an embodiment, when exposed to an amount of hydrogen peroxide, the article has an advantageous hydrogen peroxide accumulation that is less than an article absent a hydrogen peroxide degradation catalyst. For instance, the polymer composition has a hydrogen peroxide accumulation of less than 100 ng/mL when exposed to an amount of hydrogen peroxide of 100 ppb for 60 minutes. In an embodiment, the polymer composition has a hydrogen peroxide accumulation that decreases by at least 50% compared to a polymer composition absent a hydrogen peroxide degradation catalyst.

In an embodiment, the polymer composition includes at least one silicone elastomer. The at least one silicone elastomer may, for example, include a polyorganosiloxane. Any polyorganosiloxane is envisioned and includes, for instance, a silicon hydride-containing polyalkylsiloxane, a vinyl-containing polyalkylsiloxane, an aryl-containing polyalkylsiloxane, a hydroxy-containing polyalkylsiloxane, a halogen-containing polyalkylsiloxane, or combination thereof. In an embodiment the polyorganosiloxane may include any alkyl group, such as any C1-6 alkyl group or combination thereof. In an embodiment, the polyorganosiloxane may be formed of a precursor, such as dimethylsiloxane, diethylsiloxane, dipropylsiloxane, methylethylsiloxane, methylpropylsiloxane, or combinations thereof. In a particular embodiment, the polyorganosiloxane includes a polydialkylsiloxane, such as polydimethylsiloxane (PDMS). In a particular embodiment, the polyorganosiloxane is a silicon hydride-containing polyalkylsiloxane, such as a silicon hydride-containing polydimethylsiloxane. In a further embodiment, the polyorganosiloxane is a vinyl-containing polyalkylsiloxane, such as a vinyl-containing polydimethylsiloxane. In yet another embodiment, the silicone elastomer is a combination of a silicon hydride-containing polyalkylsiloxane and a vinyl-containing polyalkylsiloxane, such as a combination of silicon hydride-containing polydimethylsiloxane and a vinyl-containing polydimethylsiloxane.

In an example, the silicone elastomer may include a halide functional group, a phenyl functional group, or combination thereof. For example, the silicone elastomer may include fluorosilicone or phenylsilicone. Alternatively, the silicone elastomer is non-polar and is free of a halide functional group, such as chlorine and fluorine, and of a phenyl functional group.

In an embodiment, the silicone elastomer has a number-average molecular weight of at least 50 g/mol, such as 50 g/mol to 1,000,000 g/mol, such as 200,000 g/mol to 1,000,000 g/mol, such as at least 200,000 g/mol, or at least 300,000 g/mol, or at least 400,000 g/mol, or at least 500,000 g/mol, or not greater than 1,000,000 g/mol, or not greater than 800,000 g/mol, or not greater than 600,000 g/mol, or not greater than 400,000 g/mol as measured by a gas permeation chromatography (GPC) in THF. In a particular embodiment, the number-average molecular weight of the silicone elastomer is 200,000 g/mol to 1,000,000 g/mol. It will be appreciated that the properties can be within a range between any of the minimum and maximum values noted above.

In an embodiment, the silicone elastomer has a weight-average molecular weight of at least 50 g/mol, such as 50 g/mol to 1,000,000 g/mol, such as 200,000 g/mol to 1,000,000 g/mol, such as at least 200,000 g/mol, or at least 300,000 g/mol, or at least 400,000 g/mol, or at least 500,000 g/mol, or not greater than 1,000,000 g/mol, or not greater than 800,000 g/mol, or not greater than 600,000 g/mol, or not greater than 400,000 g/mol as measured by a gas permeation chromatography (GPC) in THF. In a particular embodiment, the weight-average molecular weight of the silicone elastomer is 200,000 g/mol to 1,000,000 g/mol. It will be appreciated that the properties can be within a range between any of the minimum and maximum values noted above.

In an embodiment, the silicone elastomer is present at not less than 50 wt. %, such as 50 to 99 wt. %, or even 90 to 99 wt. % of the total weight of the polymer composition. In a more particular embodiment, the silicone elastomer is present at an amount of at least 55 wt. %, or at least 60 wt. %, or at least 65 wt. %, or at least 70 wt. %, or at least 75 wt. %, or at least 80 wt. %, or at least 85 wt. %, or at least 90 wt. %, or not greater than 99 wt. %, or not greater than 97 wt. %, or not greater than 95 wt. %, or not greater than 93 wt. %, or not greater than 90 wt. %, or not greater than 85 wt. %, or not greater than 80 wt. %, or not greater than 75 wt. % of the total weight of the polymer composition. It will be appreciated that the amount of silicone elastomer can be within a range between any of the minimum and maximum values noted above.

The silicone elastomer of the polymer composition may include a conventional, commercially prepared silicone formulation. The commercially prepared silicone elastomer typically includes components such as the polyorganosiloxane, a catalyst, a filler, and optional additives. Any reasonable filler and additives are envisioned. Particular embodiments of a commercially available silicone elastomer includes high consistency rubber (HCR), a liquid silicone rubber (LSR), the like, or combination thereof. In an embodiment, the commercially available silicone elastomer is a high consistency rubber.

The polymer composition further includes a hydrogen peroxide degradation catalyst. Typically, the hydrogen peroxide degradation catalyst is included in the polymer composition to decrease the degradation of the polymer composition when exposed to hydrogen peroxide. Any reasonable hydrogen peroxide degradation catalyst is envisioned. For instance, the hydrogen peroxide degradation catalyst includes a metal oxide such as a transition metal oxide, an oxide of lanthanoid series, or combination thereof. In a particular embodiment, the metal oxide includes manganese dioxide (MnO₂), cerium dioxide (CeO₂), zirconium dioxide (ZrO₂), the like, or combination thereof. Other hydrogen peroxide degradation catalysts may include, for example, iron oxide, titanium dioxide, a noble metal catalyst such as silver (Ag) catalyst, platinum catalyst, the like, or combination thereof. In an embodiment, the metal oxide consists essentially of manganese dioxide, cerium dioxide, zirconium dioxide, or combination thereof. As used herein, the phrase “consists essentially of” used in connection with the metal oxide precludes the presence of other hydrogen peroxide degradation catalysts that affect the basic and novel characteristics of the polymer composition, although, commonly used processing agents and additives may be used in the polymer composition. In a particular embodiment, the metal oxide consists of manganese dioxide, cerium dioxide, zirconium dioxide, or combination thereof.

In an embodiment, the hydrogen peroxide degradation catalyst is present at any reasonable amount. For instance, the hydrogen peroxide degradation catalyst is present at an amount of 0.1 wt % to 30 wt %, such as 1 wt % to 30 wt %, such as 1 wt % to 20 wt %, such as 1 wt % to 10 wt %, or even 1 wt % to 5 wt %, based on the total weight of the polymer composition. It will be appreciated that the amount of hydrogen peroxide degradation catalyst can be within a range between any of the minimum and maximum values noted above.

A filler may be further included in the polymer composition. The filler may include any reasonable filler. In an embodiment, the filler includes silica, a pigment, a silicate clay, or combination thereof. Any amount of filler is envisioned and when present, is in an amount of 1 wt % to 70 wt %, such as 5 wt % to 50 wt %, or even 10 wt % to 40 wt %, based on the total weight of the polymer composition. It will be appreciated that the amount of filler can be within a range between any of the minimum and maximum values noted above.

In an embodiment, the polymer composition may further include a catalyst. Typically, the catalyst is present to initiate the crosslinking process. Any catalyst is envisioned depending upon the silicone composition. In an embodiment, the catalyst includes a hydrosilylation reaction catalyst. For instance, an exemplary hydrosilylation catalyst is an organometallic complex compound of a transition metal. In an embodiment, the catalyst includes platinum, rhodium, ruthenium, the like, or combination thereof. In a particular embodiment, the catalyst includes platinum. Further optional catalysts may be used with the hydrosilylation catalyst. Exemplary optional catalysts may include peroxide, tin, or combination thereof. In an embodiment, the silicone composition further includes a peroxide catalyzed silicone composition. For instance, the catalyst may be present at greater than 0.1 wt. %, such as 0.1 to 5 wt. %, or even 1 to 3 wt. % of the total weight of the polymer composition. In a more particular embodiment, the catalyst is present at an amount of at least 0.1 wt. %, or at least 0.5 wt. %, or at least 1.0 wt. %, or at least 1.5 wt. %, or at least 2.0 wt. %, or at least 2.5 wt. %, or at least 3.0 wt. %, or at least 3.5 wt. %, or not greater than 5 wt. %, or not greater than 4.5 wt. %, or not greater than 4.0 wt. %, or not greater than 3.5 wt. %, or not greater than 3.0 wt. %, or not greater than 2.5 wt. %, or not greater than 2.0 wt. %, or not greater than 1.5 wt. % of the total weight of the polymer composition. It will be appreciated that the amount of catalyst can be within a range between any of the minimum and maximum values noted above.

The polymer composition may further include an additive. Any reasonable additive is envisioned. Exemplary additives may include, individually or in combination, a curing agent, a crosslinker, an adhesion promoter, an initiator, an inhibitor, a colorant, a pigment, a carrier material, an anti-microbial, or any combination thereof. In an embodiment, the polymer composition is substantially free of an additive, such as present at less than 0.1 wt. % of an additive based on the total weight of the polymer composition. In an embodiment, the polymer content of the article is essentially 100% silicone elastomer. In some embodiments, the polymer composition consists essentially of the respective silicone elastomer, the hydrogen peroxide degradation catalyst, filler, and catalyst described above. As used herein, the phrase “consists essentially of” used in connection with the polymer composition precludes the presence of non-silicone polymers that affect the basic and novel characteristics of the polymer composition, although, commonly used processing agents and additives may be used in the polymer composition. In an embodiment, the polymer composition consists of the respective silicone elastomer, the hydrogen peroxide degradation catalyst, filler, and catalyst described above.

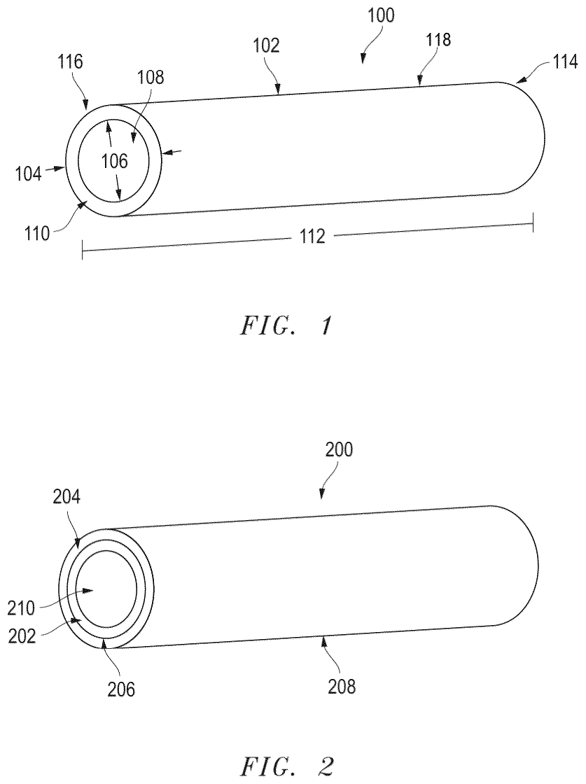

FIG. 1 is a view of an exemplary article, such as a tube 100 according to an embodiment. In a particular embodiment, the tube 100 can include a body 102 having an outside diameter 104 and an inner diameter 106. The inner diameter 106 can form an inner surface 108 of the body 102. The inner surface 108 defines a central lumen of the tube. In addition, the body 102 is illustrated as a single layer, the single layer including the polymer composition. The layer can include a thickness 110 that is measured by the difference between the outside diameter 104 and the inner diameter 106.

Any reasonable outside diameter 104 is envisioned. In a particular embodiment, the outside diameter 104 of the body 102 is about 0.09 inches (2.286 mm) to about 5 inches (127 mm). It will be appreciated that the outside diameter 104 can be within a range between any of the minimum and maximum values noted above. Any reasonable inside diameter 106 is envisioned. In an embodiment, the inner diameter 106 of the body 102 is about 0.005 inches (0.127 mm) to about 4 inches (101.6 mm). It will be appreciated that the inner diameter 106 can be within a range between any of the minimum and maximum values noted above.

Further, the body 102 can have a length 112, which is a distance between a distal end 114 and a proximal end 116 of the tube 100. Any reasonable length 112 is envisioned. In a further embodiment, the length 112 of the body 102 can be at least 0.1 meters, such as at least 1 meter, such as at least 2 meters, such as at least 5 meters, such as at least 10 meters. The length 112 is generally limited by pragmatic concerns, such as storing and transporting long lengths, or by customer demand. Further, the body 102 has a surface 118. The surface 118 can be an outer surface of the tube 100. In an embodiment, at least the surface 118 is directly exposed to vapor hydrogen peroxide. In an embodiment, the inner surface 108 is directly exposed to vapor hydrogen peroxide.

Although the cross-section of the hollow bore 108 perpendicular to an axial direction of the body 102 in the illustrative embodiment shown in FIG. 1 has a circular shape, the cross-section of the hollow bore 108 perpendicular to the axial direction of the body 102 can have any cross-section shape envisioned.

In an alternative embodiment and as seen in FIG. 2, an exemplary tube 200 is an elongated annular structure with a hollow central bore. The tube 200 includes an inner layer 202 and an outer layer 204. The outer layer 204 is illustrated as a coating overlying the inner layer 202. The inner layer 202 may be directly in contact with and may directly bond to the outer layer 204 along an outer surface 206 of the inner layer 202. As illustrated, the outer layer 204 provides an outside surface 208 of the tube 200. In an example, the inner layer 202 may directly bond to the outer layer 204 without intervening adhesive layers, such as a primer. In another example, the inner layer 202 may be adjacent to the outer layer 204 with an adhesive layer (not shown) therebetween.

As illustrated, the inner layer 202 includes an inner surface 210 that defines a central lumen of the tube. In an embodiment, the outer layer 204 includes the polymer composition including the silicone elastomer and the hydrogen peroxide degradation catalyst. Outer layer 204 may be referred to as “a hydrogen peroxide catalytic degradation layer”. In an embodiment, the inner layer 202 may be the same or different material than the outer layer 204. For instance, the inner layer 202 may include the same or different polymer as the outer layer 204 and may or may not include a hydrogen peroxide degradation catalyst.

In an example, the inner layer 202 is an elastomeric polymer. Exemplary elastomeric polymers are envisioned and include, for example, a silicone elastomer, a polystyrene, a polyester, a silicone copolymer, silicone thermoplastic vulcanizate, a copolyester, a polyamide, a fluoropolymer, a polyethylene, a polypropylene, a polyether-ester copolymer, a thermoplastic urethane, a polyether amide block (PEBA) copolymer, a polyamide copolymer, a styrene block copolymer, a polycarbonate, a polyolefin elastomer, a thermoplastic vulcanizate, an ionomer, a polyoxymethylene (POM), an acrylonitrile butadiene styrene (ABS), an acetal, an acrylic, a polyvinyl chloride (PVC), a blend, or combination thereof. In a more particular embodiment, the elastomeric polymer is a silicone elastomer that includes a polyorganosiloxane as described above. In an embodiment, the inner layer 202 does not include any hydrogen peroxide degradation catalyst.

Although illustrated as a single layer tube and a two layer tube, any number of layers is envisioned. For instance, the tube includes one layer, two layers, three layers, or even a greater number of layers. Typically, the layer has a thickness of at least about 0.05 mm to about 10 mm. It will be appreciated that the thickness of the layer can be within a range between any of the minimum and maximum values noted above. Irrespective of the number of layers present, the outside diameter and inner diameter of the tube can have any values as defined for the single layer tube 100 defined in FIG. 1. The number of layers is dependent upon the final properties desired for the tube. In an embodiment, the polymer composition including the silicone elastomer and hydrogen peroxide degradation catalyst provides an outside layer of the tube. In a more particular embodiment, the outside layer provides an outside and external surface of the tube. For instance, the layer including the silicone elastomer and hydrogen peroxide degradation catalyst may be a separate layer adjacent to a base layer, the base layer being the same or different polymer composition with or without a hydrogen peroxide degradation catalyst. Any configuration or location of the polymer composition including the silicone elastomer and hydrogen peroxide degradation catalyst is envisioned within the article.

In an embodiment, the polymer composition may be formed into a single layer article, a multi-layer article, or can be laminated, coated, or formed on a substrate. Multi-layer articles may include layers such as a polymeric layer, a reinforcing layer, an adhesive layer, a barrier layer, a chemically resistant layer, a metal layer, any combination thereof, and the like. When the article is a tube and the tube includes multiple layers, each of the individual layers of the tube may be formed by any reasonable means and is dependent upon the material and the configured location of each of the individual layers. Any number of layers is also envisioned. Although primarily described as a tube, the polymer composition can be formed into any useful shape such as film, sheet, tubing, and the like. The polymer composition may adhere or bond to other substrates including other polymers.

In an embodiment, the polymer composition may be formed by any reasonable means depending upon the final article desired. In an embodiment, the polymer composition is formed into a tube by extrusion or injection molding followed by cure such as thermal cure, radiation cure, or combination thereof.

In an exemplary embodiment, the polymer composition is formed by an extrusion system. The extrusion system for the polymer composition typically includes a pumping system and can include a number of devices that can be utilized to form the article. For example, the extrusion system can include a pumping device such as a gear pump, a static mixer, an extruder, a tube die, a thermal cure device, a radiation cure device, a post-processing device, or any combination thereof. The method includes receiving, by an extrusion system, the mixed polymer composition as described above. Any reasonable mixing apparatus is envisioned. In a particular embodiment, the mixing apparatus forms a homogenous mixture of the silicone elastomer with a homogenous distribution of hydrogen peroxide degradation catalyst. In an embodiment, heat may also be applied to the polymer composition. For instance, any reasonable heating temperature for the components of the polymer composition may be used to provide a material that can flow from the pumping system and extruded through the tube die without degradation of the material. For instance, the temperature may be about 10° C. to about 70° C. It will be appreciated that the heating temperature can be within a range between any of the minimum and maximum values noted above. Typically, the polymer composition is mixed and pumped, i.e. extruded, through the tube die of the extrusion system.

In an alternative embodiment, the article is formed by an injection molding system. The injection molding system includes any pumping system to deliver the polymer composition such as pneumatically, hydraulically, gravitationally, mechanically, and the like, or combination thereof. The pumping system delivers the polymer composition to a mold configured in any shape desired for the final article, such as a tube. The pumping system may also include any reasonable mixing apparatus envisioned. In a particular embodiment, the mixing apparatus forms a homogenous mixture of the silicone elastomer and the hydrogen peroxide degradation catalyst. Further, the pumping system may include a method of heating any combination of the components of the polymer composition to any temperature envisioned so that it has a desirable viscosity for delivery such that the polymer composition may flow into the mold. The injection molding system may further include a thermal cure device, a radiation cure device, a post-processing device, or any combination thereof.

In an embodiment, the polymer composition is thermally cured. In an embodiment, the thermal curing of the polymer composition can include subjecting the polymer composition to one or more heat sources. In a particular embodiment, the heat source is sufficient to substantially cure the polymer composition. “Substantially cure” as used herein refers to 90% to 100% curing degree, as determined for instance by rheometer data (90% cure means the material reaches 90% of the maximum torque as measured by ASTM D5289). For instance, the level of cure is to provide desirable properties for the final article.

In an embodiment, the polymer composition is radiation cured. Any number of applications of radiation energy may be applied with the same or different wavelengths. For example, the extrusion system or injection molding system can include one or more ovens (e.g. infrared (IR) ovens, air ovens), one or more baths (e.g. water baths), or a combination thereof, to cure the polymer composition. The one or more IR ovens can operate at a particular peak wavelength. In certain instances, the peak wavelength of a first IR oven can be different from the peak wavelength of a second IR oven. In an embodiment, the polymer composition can be subjected to a heat treatment for a specified period of time. In a particular embodiment, the polymer composition can be subjected to curing in a first IR oven for a first period of time and then subject to curing in a second IR oven for a second period of time that is different from the first period of time. In one particular embodiment, use is made of a short wavelength IR oven. By short wavelength, it is meant that the peak wavelength is below 4 microns, typically below 3 microns, such as within a range of approximately 0.6 to 2.0 microns, such as 0.8 to 1.8 microns. Generally medium and longer wavelength IR ovens are characterized by a peak wavelength on the order of 4 to 8 microns, or even higher. It will be appreciated that the wavelength can be within a range between any of the minimum and maximum values noted above.

Once the polymer composition is formed, the polymer composition can undergo one or more post processing operations. Any reasonable post processing operations are envisioned. For instance, the polymer composition can be subjected to a post-cure heat treatment, such as a post-curing cycle. Post thermal treatment typically occurs at a temperature of about 40° C. to about 200° C. In an embodiment, the post thermal treatment is at a temperature of about 60° C. to about 100° C. Typically, the post thermal treatment occurs for a time period of about 5 minutes to about 10 hours, such as about 10 minutes to about 30 minutes, or alternatively about 1 hour to about 4 hours. It will be appreciated that the post thermal treatment temperature and time can be within a range between any of the minimum and maximum values noted above. In an alternative example, the polymer composition is not subjected to a post thermal treatment. In an example, the article is a tube that can be cut into a number of tubes having a specified length. In another embodiment, the post processing can include wrapping the tube into a coil of tubing.

The article can be sterilized. In an embodiment, the article may be sterilized by any method envisioned. For instance, the tube is sterilized after it is formed. Exemplary sterilization methods include hydrogen peroxide, autoclave, gamma, ethylene oxide, electron beam techniques, combinations thereof, and the like. In an embodiment, the article is hydrogen peroxide sterilized. Any reasonable conditions for vapor hydrogen peroxide (VHP) sterilization are envisioned. For instance, a typical VHP cycle includes the vaporization of an aqueous hydrogen peroxide solution, which is continuously fed into an isolator at a concentration that can range from 400 to 6000 ppm (v/v), such as 400 to 1300 (v/v) to produce a sterilization effect. In a particular embodiment, the article is sterilized by gamma irradiation. For instance, the article may be gamma sterilized at between about 10 kGy to about 200 kGy. In a particular embodiment, the article is sterilized by steam sterilization. In an exemplary embodiment, the article is heat-resistant to steam sterilization at temperatures up to about 130° C. for a time of up to about 45 minutes. In an embodiment, the article is heat resistant to steam sterilization at temperatures of up to about 135° C. for a time of up to about 15 minutes. It will be appreciated that the sterilization parameters can be within a range between any of the minimum and maximum values noted above.

In an embodiment, the resulting article may have further desirable physical and mechanical properties. For instance, the article is flexible and kink-resistant. In particular, the resulting article has desirable flexibility. For instance, the polymer composition may advantageously produce low durometer articles. For example, an article having a Shore A durometer of between about 20 and about 90, such as between about 35 to about 75 as measured by ASTM D2240 having desirable mechanical properties may be formed. Such properties are indicative of a flexible material. In an embodiment, the polymer composition has at least one of the following properties: a) a modulus at 100% elongation that changes by less than 45%, such as less than 40%, such as less than 35%, such as less than 30%, or even less than 25% compared to a polymer composition absent a hydrogen peroxide degradation catalyst; b) an ultimate strain that changes by less than 50%, such as less than 45%, such as less than 40%, such as less than 35%, such as less than 30%, or even less than 25% compared to a polymer composition absent a hydrogen peroxide degradation catalyst; or c) a tensile stress at maximum that changes by less than about 20%, such as less than 15%, or even less than 10% compared to a polymer composition absent a hydrogen peroxide degradation catalyst. It will be appreciated that the values can be within a range between any of the minimum and maximum values noted above.

In exemplary embodiments, the article can be used in a variety of applications. Applications for the article are numerous. In particular, the non-toxic nature of the silicone composition makes the article useful for any application where toxicity is undesired. For instance, the article has potential for FDA, ADCF, USP Class VI, NSF, European Pharmacopoeia compliant, United States Pharmacopoeia (USP) compliant, USP physiochemical compliant, ISO 10993 Standard for evaluating biocompatibility of a medical device, and other regulatory approvals. In a particular embodiment, the polymer composition may be non-cytotoxic, non-hemolytic, non-pyrogenic, animal-derived component-free, non-mutagenic, non-bacteriostatic, non-fungistatic, or any combination thereof.

In an embodiment, the polymer composition is any formed into any reasonable article, such as the tube, that may be used in applications such as industrial, medical applications, health care, biopharmaceutical, drinking water, food & beverage applications, dairy applications, laboratory applications, FDA applications, and the like. In an exemplary embodiment, although the article is primarily described as a tube, the article of the present invention may include any geometry envisioned; a connector, a molded part, a septum, an infusion sleeve, a pump diaphragm, a membrane, a valve, and the like. Any article is envisioned where the physical and mechanical properties of the polymer composition are advantageous.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. An article including a polymer composition, the polymer composition including a silicone elastomer and a hydrogen peroxide degradation catalyst.

Embodiment 2. A method of providing an article including: providing a polymer composition including a silicone elastomer and a hydrogen peroxide degradation catalyst; and shaping the polymer composition into an article.

Embodiment 3. An article including an inner layer including an elastomeric polymer; and an outer layer including a polymer composition, the polymer composition includes a silicone elastomer and a hydrogen peroxide degradation catalyst.

Embodiment 4. The article or the method of providing the article in accordance with any of the preceding embodiments, wherein the silicone elastomer includes a polyorganosiloxane.

Embodiment 5. The article or the method of providing the article in accordance with embodiment 4, wherein the polyorganosiloxane includes a hydride-containing polyalkylsiloxane, a vinyl-containing polyalkylsiloxane, an aryl-containing polyalkylsiloxane, a hydroxy-containing polyalkylsiloxane, a halogen-containing polyalkylsiloxane, or combination thereof.

Embodiment 6. The article or the method of providing the article in accordance with embodiment 5, wherein the polyorganosiloxane includes a hydride-containing polyalkylsiloxane, a vinyl-containing polyalkylsiloxane, or combination thereof.

Embodiment 7. The article or the method of providing the article in accordance with embodiment 5, wherein the polyorganosiloxane has a number average molecular weight of at least 50 g/mol, such as 50 g/mol to 1,000,000 g/mol, or even 200,000 g/mol to 1,000,000 g/mol.

Embodiment 8. The article or the method of providing the article in accordance with embodiment 5, wherein the polyorganosiloxane has a weight average molecular weight of at least 50 g/mol, such as 50 g/mol to 1,000,000 g/mol, or even 200,000 g/mol to 1,000,000 g/mol.

Embodiment 9. The article or the method of providing the article in accordance with any of the preceding embodiments, wherein the hydrogen peroxide degradation catalyst includes a metal oxide.

Embodiment 10. The article or the method of providing the article in accordance with embodiment 9, wherein the metal oxide includes a transition metal oxide, an oxide of the lanthanoid series, or combination thereof.

Embodiment 11. The article or the method of providing the article in accordance with embodiment 10, wherein the metal oxide includes manganese dioxide (MnO₂), cerium dioxide (CeO₂), zirconium dioxide (ZrO₂), or combination thereof.

Embodiment 12. The article or the method of providing the article in accordance with the preceding embodiments, wherein the hydrogen peroxide degradation catalyst is present at an amount of 0.1 wt % to 30 wt %, such as 1 wt % to 30 wt %, such as 1 wt % to 20 wt %, such as 1 wt % to 10 wt %, or even 1 wt % to 5 wt %, based on the total weight of the polymer composition.

Embodiment 13. The article or the method of providing the article in accordance with the preceding embodiments, wherein the polymer composition further includes a filler.

Embodiment 14. The article or the method of providing the article in accordance with embodiment 13, wherein the filler includes silica, a pigment, a silicate clay, or combination thereof.

Embodiment 15. The article or the method of providing the article in accordance with embodiment 13, wherein the filler is present at an amount of 1 wt % to 70 wt %, such as 5 wt % to 50 wt %, or even 10 wt % to 40 wt %, based on the total weight of the polymer composition.

Embodiment 16. The article or the method of providing the article in accordance with any of the preceding embodiments, further including a hydrosilylation reaction catalyst, a crosslinker, an inhibitor, or combination thereof.

Embodiment 17. The article or the method of providing the article in accordance with any of the preceding embodiments, wherein the polymer composition has a hydrogen peroxide accumulation of less than 100 ng/mL when exposed to an amount of hydrogen peroxide of 100 ppb for 60 minutes.

Embodiment 18. The article or the method of providing the article in accordance with any of the preceding embodiments, wherein the polymer composition has a hydrogen peroxide accumulation that decreases by at least 50% compared to a polymer composition absent a hydrogen peroxide degradation catalyst.

Embodiment 19. The article or the method of providing the article in accordance with any of the preceding embodiments, wherein the polymer composition has a modulus at 100% elongation that changes by less than 25% compared to a polymer composition absent a hydrogen peroxide degradation catalyst.

Embodiment 20. The article or the method of providing the article in accordance with any of the preceding embodiments, wherein the polymer composition has an ultimate strain that changes by less than about 25% compared to a polymer composition absent a hydrogen peroxide degradation catalyst.

Embodiment 21. The article or the method of providing the article in accordance with any of the preceding embodiments, wherein the polymer composition has a tensile stress at maximum that changes by less than about 15% compared to a polymer composition absent a hydrogen peroxide degradation catalyst.

Embodiment 22. The article or the method of providing the article in accordance with any of the preceding embodiments, wherein the silicone elastomer provides a matrix with a homogenous distribution of hydrogen peroxide degradation catalyst.

Embodiment 23. The article or the method of providing the article in accordance with any of the preceding embodiments, wherein the article has a shore A durometer of about 20 to about 90, as measured by ASTM D2240.

Embodiment 24. The article or the method of providing the article in accordance with any of the preceding embodiments, wherein the article is sterilized.

Embodiment 25. The article or the method of providing the article in accordance with embodiment 24, wherein the article is hydrogen peroxide sterilized, gamma sterilized, electron beam sterilized, autoclave sterilized, ethylene oxide sterilized, or combination thereof.

Embodiment 26. The article or the method of providing the article in accordance with any of the preceding embodiments, wherein the article includes a tube having an inner surface that defines a central lumen of the tube.

Embodiment 27. The article or the method of providing the article in accordance with embodiment 26, wherein the tube includes an outer layer, wherein the outer layer includes the polymer composition.

Embodiment 28. The article or the method of providing the article in accordance with embodiment 26, wherein the tube has an inner diameter of about 0.005 inches to about 4.00 inches.

Embodiment 29. The article or the method of providing the article in accordance with embodiment 26, wherein the tube has an outer diameter of about 0.09 inches to about 5.00 inches.

Embodiment 30. The article or the method of providing the article in accordance with embodiments 1-25, wherein the article includes a connector, a molded part, a septum, an infusion sleeve, a pump diaphragm, a membrane, or a valve.

Embodiment 31. The article in accordance with embodiments 3-30, wherein the elastomeric polymer includes a silicone elastomer including a polyorganosiloxane.

Embodiment 32. The article in accordance with embodiment 31, wherein the polyorganosiloxane includes a hydride-containing polyalkylsiloxane, a vinyl-containing polyalkylsiloxane, an aryl-containing polyalkylsiloxane, a hydroxy-containing polyalkylsiloxane, a halogen-containing polyalkylsiloxane, or combination thereof.

Embodiment 33. The article in accordance with embodiment 32, wherein the polyorganosiloxane includes a hydride-containing polyalkylsiloxane, a vinyl-containing polyalkylsiloxane, or combination thereof.

Embodiment 34. An article including a polymer composition, the polymer composition including a silicone elastomer and a hydrogen peroxide degradation catalyst, wherein the hydrogen peroxide degradation catalyst includes a metal oxide present at an amount of 0.1 wt % to 30 wt %, such as 1 wt % to 30 wt %, such as 1 wt % to 20 wt %, such as 1 wt % to 10 wt %, or even 1 wt % to 5 wt %, based on the total weight of the polymer composition.

Embodiment 35. The article in accordance with embodiment 34, wherein the article includes a tube having an inner surface that defines a central lumen of the tube.

The concepts described herein will be further described in the following examples, which do not limit the scope of the disclosure described in the claims. The following examples are provided to better disclose and teach processes and compositions of the present invention. They are for illustrative purposes only, and it must be acknowledged that minor variations and changes can be made without materially affecting the spirit and scope of the invention as recited in the claims that follow.

### Examples

The following example formulations illustrate the impact of a hydrogen peroxide (H₂O₂) degradation catalyst on the H₂O₂ accumulation within silicone tubings and the mechanical properties of the silicone. H₂O₂ accumulation was measured by enclosing water within the silicone tubing and exposing the sample to an H₂O₂-rich environment. The method for H₂O₂ exposure is given in the following section. The volume loading of filler (silica and hydrogen peroxide degradation catalyst) was kept constant across all samples to minimize the effects of diffusion on the H₂O₂ concentration. Formulations and testing conditions can be seen below. Results can be seen in Tables 1 and 2.

TABLE 1
Example formulations containing MnO₂ and CeO₂ decomposition
catalysts exposed to VHP environment for 24-hours.

| | Tube Wall | Catalyst | H₂O₂ | Modulus at | Ultimate | Tensile stress |
|---|---|---|---|---|---|---|
| | Thickness | loading | accumulation | 100% Elongation | strain | at maximum |
| Sample | (mm) | (wt %) | (ppm) | (MPa) | (%) | load (psi) |
| Control | 2.47 | 0.0 | 33.31 ± 2.8 | 3.41 ± 0.13 | 333 ± 14 | 7.71 ± 0.02 |
| 3% MnO₂ | 2.47 | 3.0 | 0.04 ± 0.04 | 2.04 ± 0.04 | 490 ± 29 | 6.90 ± 0.20 |
| 3% CeO₂ | 2.47 | 3.0 | 0.34 ± 0.18 | 2.30 ± 0.06 | 447 ± 52 | 7.50 ± 0.64 |

TABLE 2
Example formulations containing CeO₂ and ZrO₂ decomposition
catalysts exposed over two timescales

| | Tube Wall | Catalyst | | H₂O₂ |
|---|---|---|---|---|
| | Thickness | loading | H₂O₂ Exposure | accumulation |
| Sample | (mm) | (wt %) | Time (hours) | (ppm) |
| Control | 1.6 | 0.0 | 4 | 216 ± 13 |
| 2% CeO₂ | 1.6 | 2.0 | 4 | 88 ± 3 |
| 2% ZrO₂ | 1.6 | 2.0 | 4 | 60 ± 9 |
| Control | 1.6 | 0.0 | 24 | 1491 ± 7 |
| 2% CeO₂ | 1.6 | 2.0 | 24 | 321 |
| 2% ZrO₂ | 1.6 | 2.0 | 24 | 63 |

### Formulation

The formulation included a 30-80 durometer extrusion grade silicone, hydride crosslinker, vinyl silicone gum, platinum catalyst, and inhibitor combined at the desired ratios in a two-roll mill to form a control sample. Different hydrogen peroxide degradation catalyst were added to the control sample. The mass ratio of hydride crosslinker, vinyl silicone gum, platinum catalyst, and inhibitor were kept constant across all samples.

### Sample Fabrication

Tube and slab samples were created by compression molding. For tube samples, the silicone formulation was loaded into a tube die with either an 11.4 mm diameter cavity or a 9.66 mm diameter cavity and 6.46 mm diameter pin. The samples were cured under 24-ton pressure at 177° C. for 10 minutes. Slab samples were created by loading the formulation into a 150 mm×150 mm×2 mm slab mold. Samples were cured under 24-ton pressure at 177° C. for 10 minutes. All samples were post-cured in a convection oven at 196° C. for 2 hours.

### Mechanical Testing

Mechanical testing was performed according to ASTM D412 with samples cut from slabs using a type C die. The gage length was set to 25 mm and pull speed at 20 inches/min using an Instron for measurement.

H₂O₂ Accumulation Testing

H₂O₂ accumulation was measured by simulating an isolator environment. Tubing samples were cut to 9 cm in length. The samples were filled with reverse osmosis purified water, being careful to not allow any air bubbles into the tubing. 1 cm of tubing length was clamped shut at each end of the tubing. Ajar was filled with 30 g of 30% H₂O₂(Certified ACS grade, Fisher Scientific). The jar of H₂O₂ solution and all samples were placed into a 2700 mL sealed glass container. Air was bubbled through the H₂O₂ solution using a battery powered pump (DC-160, Resun®). The samples were left in the sealed container for 4-24-hours at which point the water was recovered from within the tubing for measurement.

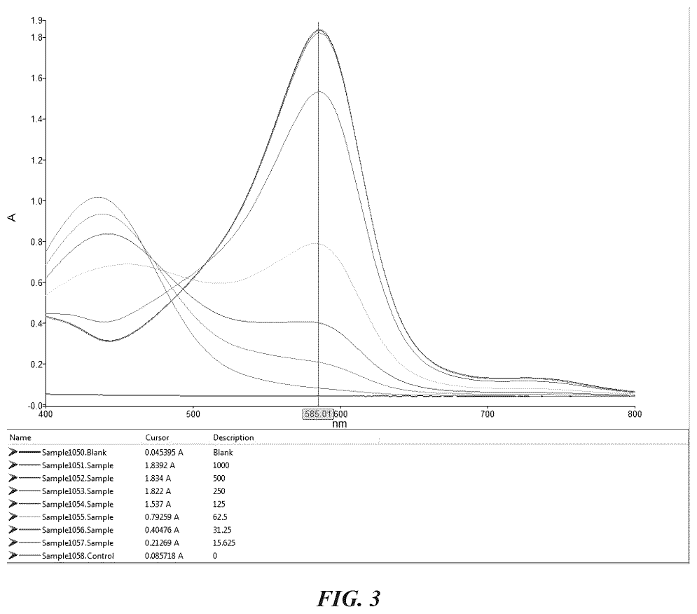

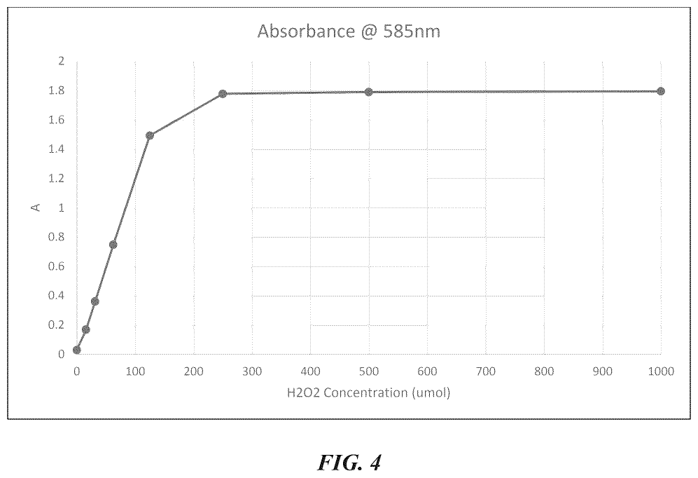

H₂O₂ concentration within the recovered samples was measured using a Pierce™ Quantitative Peroxide Assay (ThermoFisher Scientific) and analyzed using a UV-VIS spectrophotometer (Lambda 950, Perkin Elmer) according to manufacturer procedures. A standard curve was prepared by diluting a 30% H₂O₂ stock solution (Certified ACS grade, Fisher Scientific) to 1000 μM followed by further serial dilutions. The absorbance was measured at the absorbance peak at 585 nm. H₂O₂ concentrations of recovered samples were determined by first diluting the samples into the absorbance range dictated by the standard curve. The absorbance values were correlated to a concentration value (μM) using a linear fit between incremental dilutions of the standard curve. The absorbance graph and standard curve are provided in FIGS. 3 and 4, respectively.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. An article comprising a polymer composition, the polymer composition comprising a silicone elastomer and a hydrogen peroxide degradation catalyst.

2. The article in accordance with claim 1, wherein the silicone elastomer comprises a polyorganosiloxane.

3. The article in accordance with claim 2, wherein the polyorganosiloxane comprises a hydride-containing polyalkylsiloxane, a vinyl-containing polyalkylsiloxane, an aryl-containing polyalkylsiloxane, a hydroxy-containing polyalkylsiloxane, a halogen-containing polyalkylsiloxane, or combination thereof.

4. The article in accordance with claim 1, wherein the hydrogen peroxide degradation catalyst comprises a metal oxide.

5. The article in accordance with claim 4, wherein the metal oxide comprises a transition metal oxide, an oxide of the lanthanoid series, or combination thereof.

6. The article in accordance with claim 5, wherein the metal oxide comprises manganese dioxide (MnO₂), cerium dioxide (CeO₂), zirconium dioxide (ZrO₂), or combination thereof.

7. The article in accordance with claim 1, wherein the hydrogen peroxide degradation catalyst is present at an amount of 0.1 wt % to 30 wt %, such as 1 wt % to 30 wt %, such as 1 wt % to 20 wt %, such as 1 wt % to 10 wt %, or even 1 wt % to 5 wt %, based on the total weight of the polymer composition.

8. The article in accordance with claim 1, further comprising a hydrosilylation reaction catalyst, a crosslinker, an inhibitor, a filler, or combination thereof.

9. The article in accordance with claim 1, wherein the polymer composition has a hydrogen peroxide accumulation that decreases by at least 50% compared to a polymer composition absent a hydrogen peroxide degradation catalyst.

10. The article in accordance with claim 1, wherein the polymer composition has a modulus at 100% elongation that changes by less than 25% compared to a polymer composition absent a hydrogen peroxide degradation catalyst.

11. The article in accordance with claim 1, wherein the polymer composition has an ultimate strain that changes by less than about 25% compared to a polymer composition absent a hydrogen peroxide degradation catalyst.

12. The article in accordance with claim 1, wherein the polymer composition has a tensile stress at maximum that changes by less than about 15% compared to a polymer composition absent a hydrogen peroxide degradation catalyst.

13. The article in accordance with claim 1, wherein the article comprises a tube having an inner surface that defines a central lumen of the tube.

14. The article in accordance with claim 13, wherein the tube comprises an outer layer, wherein the outer layer comprises the polymer composition.

15. An article comprising a polymer composition, the polymer composition comprising a silicone elastomer and a hydrogen peroxide degradation catalyst, wherein the hydrogen peroxide degradation catalyst comprises a metal oxide present at an amount of 0.1 wt % to 30 wt %, such as 1 wt % to 30 wt %, such as 1 wt % to 20 wt %, such as 1 wt % to 10 wt %, or even 1 wt % to 5 wt %, based on the total weight of the polymer composition.

16. The article in accordance with claim 15, wherein the metal oxide comprises a transition metal oxide, an oxide of the lanthanoid series, or combination thereof.

17. A method of providing an article comprising:
providing a polymer composition comprising a silicone elastomer and a hydrogen peroxide degradation catalyst comprising a metal oxide; and
shaping the polymer composition into an article.

18. The method of providing the article in accordance with claim 17, wherein the article is sterilized.

19. The method of providing the article in accordance with claim 18, wherein the article is hydrogen peroxide sterilized, gamma sterilized, electron beam sterilized, autoclave sterilized, ethylene oxide sterilized, or combination thereof.

20. The method of providing the article in accordance with claim 17, wherein the metal oxide comprises a transition metal oxide, an oxide of the lanthanoid series, or combination thereof.
